(19) United States
(12) Patent Application Publication
(10) Pub. No.: US 2008/0202046 A1
(43) Pub. Date: Aug. 28, 2008

(54) SASH WINDOW ASSEMBLY

(75) Inventor: Takeru Fujii, Tokyo (JP)

Correspondence Address: DARBY & DARBY P.C., P.O. BOX 770, Church Street Station, New York, NY, 10008-0770, US

(73) Assignee: YKK AP INC., Tokyo (JP)

(21) Appl. No.: 12/027,354

(22) Filed: Feb. 7, 2008

(30) Foreign Application Priority Data
Feb. 22, 2007 (JP) 2007-042436

(51) Int. Cl. E06B 3/96; E06B 1/04

(52) U.S. Cl. 52/204.62; 52/213

(57) ABSTRACT

A sash window assembly includes a face material provided in an opening section open to an indoor and outdoor side, a frame section provided within the opening section, and beads attached to the frame section with the ends of the beads angled and butted against one another, the beads for pressing upon the face material from one of the indoor and outdoor directions, wherein each of the beads includes a first engaging section and a second engaging section, the first engaging section engaging with the frame section at a front-side in a movement direction, the second engaging section engaging with the frame further toward a rear-side in the movement direction than the first engaging section, when the bead is moved in the movement direction along a depth direction; the frame section includes a first engaging projection that engages with the first engaging section, a second engaging projection that engages with the second engaging section, and a recess provided between the first engaging projection and the second engaging projection, the recess being recessed toward an inner side of the frame section; and each of the beads is moved with the first engaging section of each bead inserted into the recess, the first engaging section being engaged with the first engaging projection in a state where the bead is tilted so that the second engaging section moves away from the frame section, the second engaging section being engaged with the second engaging projection by rotating the bead in a direction that brings the second engaging section closer to the frame section.

### CROSS-REFERENCE TO RELATED APPLICATIONS

The present application claims priority upon Japanese Patent Application No. 2007-042436 filed on Feb. 22, 2007, which is herein incorporated by reference.

### BACKGROUND

1. Technical Field

The present invention relates to a sash window assembly, and particularly relates to a sash window assembly including a face material provided in an opening section that is open to an indoor side and an outdoor side, a frame section provided within the opening section, and beads attached to the frame section with the ends of the beads angled and butted against one another.

2. Related Art

A sash window assembly including a face material provided in an opening section that is open to an indoor side and an outdoor side, a frame section provided within the opening section, and beads attached to the frame section with the ends of the beads angled and butted against one another, is known. This sash window assembly is found in a fixed window, in which an upper bead and a pair of vertical beads support glass from the indoor side and are fastened to an upper frame member or vertical frame members. The upper bead and vertical beads are butted together, their ends being formed at a 45-degree angle (for example, see JP-A-2004-285597).

Because the ends of the beads are formed at a 45-degree angle, thus making the outer edge of the bead longer and the inner edge of the bead shorter, when beads are butted together at a 45-degree angle and are attached to the frame section, the upper, lower, left, and right beads cannot be fastened to the frame body while moving the beads toward the end side from the center of the face material. Accordingly, the above-mentioned conventional fixed window has a configuration in which the upper bead is moved in the upper direction after being moved in the depth direction and unfastened, thereby forming a space between the upper bead and the vertical beads. Then, using this space, the vertical beads are unfastened from the vertical frame member, and the vertical beads can be removed.

However, the beads used in the above-mentioned conventional fixed window are problematic. First, the vertical beads cannot be removed unless the upper bead is unfastened and then moved in the upper direction. Furthermore, the upper bead is unfastened when removing the vertical beads, and thus the upper bead is required to be supported somehow in the upward direction, resulting in a complicated procedure for removing the bead.

### SUMMARY

The present invention was achieved in view of the above-described problems, and it is an advantage thereof to provide a sash window assembly with which beads can be butted against one another at an angle and attached to a frame section with ease.

An aspect of the invention is a sash window assembly including a face material provided in an opening section that is open to an indoor side and an outdoor side, a frame section provided within the opening section, and beads attached to the frame section with the ends of the beads angled and butted against one another, the beads for pressing upon the face material from one direction of the indoor and outdoor directions,

wherein each of the beads includes a first engaging section and a second engaging section, the first engaging section engaging with the frame section at a front-side in a movement direction, the second engaging section engaging with the frame further toward a rear-side in the movement direction than the first engaging section, when the bead is moved in the movement direction following along a depth direction;

the frame section includes a first engaging projection that engages with the first engaging section, a second engaging projection that engages with the second engaging section, and a recess provided between the first engaging projection and the second engaging projection, the recess being recessed toward an inner side of the frame section; and

each of the beads is moved with the first engaging section of each bead inserted into the recess, the first engaging section being engaged with the first engaging projection in a state where the bead is tilted so that the second engaging section moves away from the frame section, the second engaging section being engaged with the second engaging projection by rotating the bead in a direction that brings the second engaging section closer to the frame section.

Beads that have angled ends and which are butted against one another are formed so that the length of the edge on the outer side of the frame section (referred to hereinafter as the “outer edge”) is longer than the edge on the center side of the face material (referred to hereinafter as the “inner edge”). For this reason, it is difficult to attach the four beads that support all sides of the face material to the four frame elements by moving the beads along the surface of the face material, from the center side of the face material toward the inner sides of the frame sections. Specifically, three beads can be attached by moving the beads along the surface of the face material, from the center side of the face material toward the inner sides of the frame sections. However, when two beads adjacent to the bead that is to be attached are already attached, and the fourth bead is to be attached between these adjacent beads, the ends of the fourth bead make contact with the ends of the beads that are already attached, and thus cannot be attached.

However, according to the sash window assembly of the invention, the bead is moved with the first engaging section inserted into the recess that is recessed toward the inner side of the frame section, thereby engaging the first engaging section with the frame section at the front-side in the movement direction; therefore, the position of the front end of the bead during this movement is located further toward the inner side of the frame section than the position of the front end of the bead after the bead has been attached to the frame section. Accordingly, even if two beads are already attached to the frame section so as to be adjacent to the bead that is to be attached, it is possible to allow for a space between the ends of the two already-attached adjacent beads and the bead that is to be attached when moving the bead in the depth direction. In addition, because there is a space between the bead that is to be attached and the ends of the adjacent beads, the rear-end side of the bead that is to be attached can be moved in the direction away from the second engaging projection, and the bead can therefore be tilted. Furthermore, by moving the bead that is to be attached into the space between the adjacent beads in the tilted state, the second engaging section can be moved further toward the front-side in the movement direction than the second engaging projection without the second engaging section coming in contact with the second engaging projection. When the second engaging section is moved further to the front-side in the movement direction than the second engaging projection, the first engaging section and the first engaging projection are engaged with one another, and when the bead is rotated so that the second engaging section moves in the direction that brings it closer to the frame section, the second engaging section and the second engaging projection are engaged with one another, making it possible to attach the bead with ease, even if the bead has ends that are angled and that butt up against one another.

In the sash window assembly, it is preferable that the second engaging section includes a movement limiting projection piece that limits the movement of the bead toward the rear-side in the movement direction; and the movement limiting projection piece is made to contact with the second engaging projection at the front-side in the movement direction by the second engaging section being engaged with the second engaging projection.

According to such a sash window assembly, the movement limiting projection piece is made to contact with the second engaging projection at the front-side in the movement direction by the second engaging section and the second engaging projection engaging with one another. Therefore, when attaching the bead, the movement of the bead toward the rear-side in the movement direction is limited, making it possible to attach the bead to the frame section in a state where it is difficult for the bead to become detached.

In the sash window assembly, it is preferable that the second engaging section includes a rotation limiting projection piece that limits the rotation of the bead in the direction that brings the second engaging section closer to the frame section; and the rotation limiting projection piece is made to contact with the second engaging projection by the second engaging section being engaged with the second engaging projection.

According to such a sash window assembly, the rotation limiting projection piece makes contact with the second engaging projection by the second engaging section and the second engaging projection engaging with one another. Therefore, when attaching the bead, the rotation of the bead in the direction that brings the second engaging section closer to the frame section is limited, which maintains the state in which the movement limiting projection piece makes contact with the second engaging projection, making it possible to attach the bead to the frame section in a state where it is even more difficult for the bead to become detached.

In the sash window assembly, it is preferable that an elastic sealant is provided between the face material and the beads; and the movement limiting projection piece and the rotation limiting projection piece are pressed upon the second engagement projection by the sealant.

According to such a sash window assembly, the movement limiting projection piece and the rotation limiting projection piece are pressed upon the second engaging projection with the elastic sealant provided between the face material and the bead. Therefore, the bead is pressed so that movement in the direction opposite to the movement direction when attaching the bead, and rotation in the direction in which the second engaging section moves away from the frame section, are both limited, making it possible to attach the bead to the frame section in a state where it is even more difficult for the bead to become detached. At this time, reactive force arises between the sealant and the face material, making it possible to securely hold the face material in place.

According to the present invention, it is possible to provide a sash window assembly with which beads can be butted against one another at an angle and attached to a frame section with ease.

Features and objects of the present invention other than the above will become clear by reading the description of the present specification with reference to the accompanying drawings.

### BRIEF DESCRIPTION OF THE DRAWINGS

For a more complete understanding of the invention and the advantages thereof, reference is now made to the following description taken in conjunction with the accompanying drawings wherein:

FIG. 1 is a front view of a sash window assembly according to an embodiment of the present invention, as viewed from an indoor side;

FIG. 2 is a cross-sectional view of the sash window assembly according to the embodiment of this invention;

FIG. 3 is a diagram illustrating a bead according to the embodiment of this invention;

FIG. 4 is a diagram illustrating a method for attaching the bead according to the embodiment of this invention;

FIG. 5 is a diagram illustrating a space arising between beads adjacent to the upper-side bead; and

FIG. 6 is a diagram illustrating a method for detaching the bead according to the embodiment of this invention.

### DESCRIPTION OF EXEMPLARY EMBODIMENTS

At least the following matters will be made clear by the explanation in the present specification and the description of the accompanying drawings.

A sash window assembly according to an embodiment of the invention shall be described hereinafter with reference to the drawings.

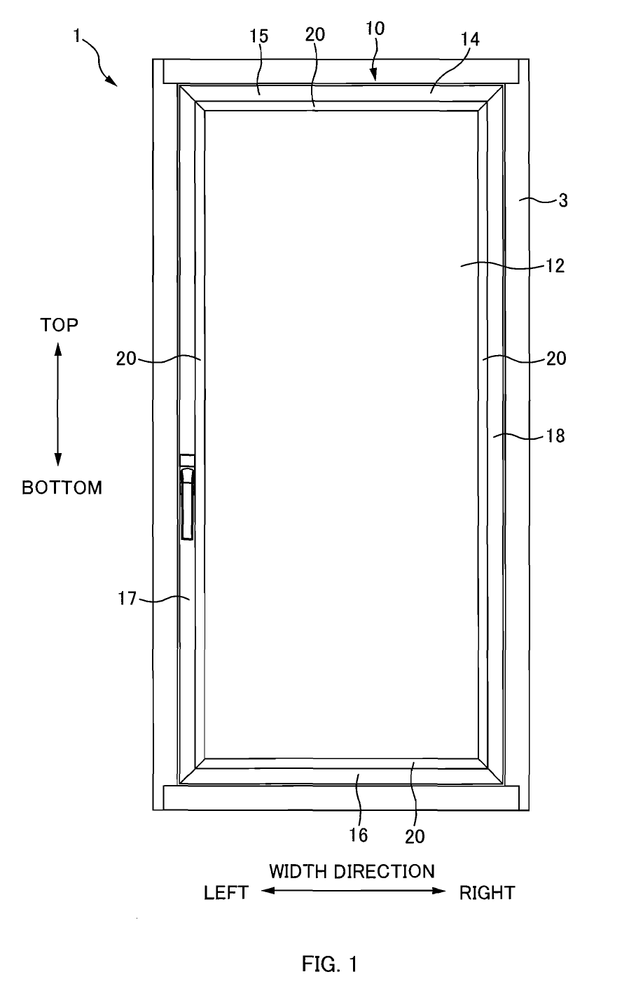

The present embodiment describes, as an example, a sash window assembly in which sashes are supported so as to be rotatable within a sash frame provided in an opening section that is open between an indoor side and an outdoor side, thereby making the area within the sash frame openable/closable, as shown in FIG. 1.

In the following descriptions, the direction that appears vertical when a sash window assembly 1 is viewed from the indoor side shall be referred to as the “vertical direction”; the direction that appears horizontal shall be referred to as the “horizontal direction” or a “width direction”; and the direction spanning between an indoor side and an outdoor side shall be referred to as the “depth direction”.

The sash window assembly 1 according to the present embodiment includes, for example, sash frame members 3 attached to the framework of a building, and a sash 10, supported at the top and bottom at one end, in the width direction, with the sash frame members 3, so as to be rotatable, as shown in FIG. 1.

The sash 10 includes: a glass 12 serving as the face material provided in the opening section; a frame body 14 serving as a frame member provided within the opening section; and beads 20 attached to the frame body 14 so that the ends of the beads 20 are angled and butt against one another, the beads 20 supporting the glass 12 from one side in the depth direction.

The frame body 14 is assembled in a rectangular shape by cutting both ends of an upper frame element 15 and a lower frame element 16 provided at the top and bottom, respectively, of the glass 12, and vertical frame elements 17 and 18 provided at the left and right, respectively, of the glass 12 to 45-degree angles, and butting the ends up against one another. The frame elements 15, 16, 17, and 18 are all aluminum members formed through extrusion molding.

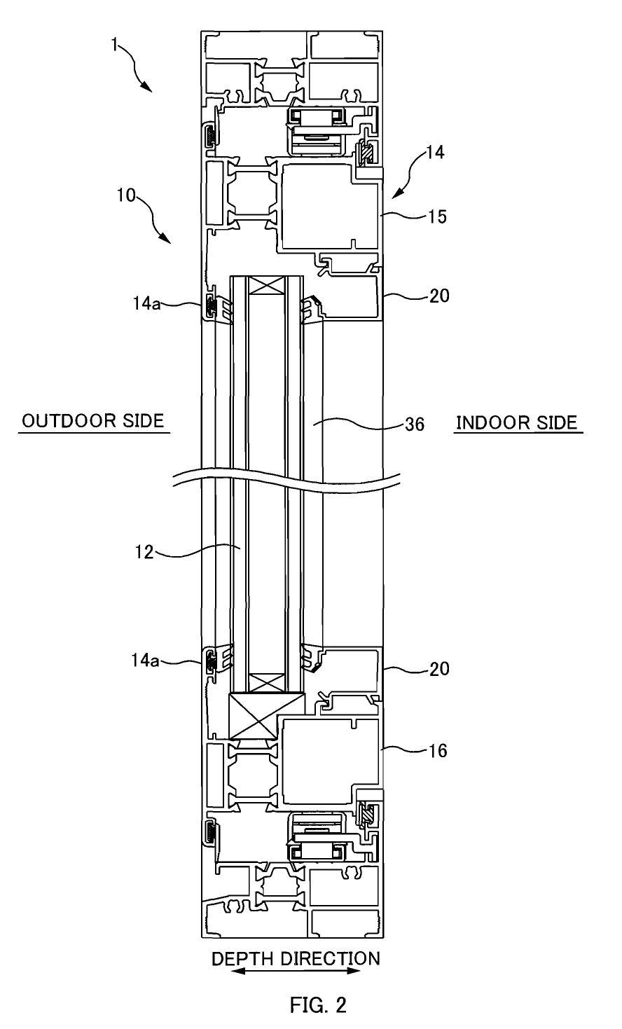

As illustrated in FIG. 2, the frame body 14 is formed so that the inner circumference of the opening on the indoor side is larger than the inner circumference of the opening on the outdoor side. The glass 12 is sandwiched by a section 14a, located on the outdoor side, that protrudes in the central direction of the glass 12 toward the indoor side, and the beads 20, which are attached to the frame elements 15, 16, 17, and 18, respectively, to the center side of the glass 12, on the indoor side of the frame elements 15, 16, 17, and 18. In other words, a single bead 20 is attached to each of the upper frame element 15, the lower frame element 16, and the left and right vertical frame elements 17 and 18, respectively.

The four beads 20 are all aluminum members formed through extrusion molding, and both ends thereof are cut to 45-degree angles. The ends of adjacent beads 20 are butted against one another and attached to the frame elements 15, 16, 17, and 18. For this reason, the upper and lower beads 20 attached to the upper frame element 15 and lower frame element 16, respectively, are identical members. Likewise, the left and right beads 20 attached to the left and right vertical frame elements 17 and 18, respectively, are identical members. Only the direction of attachment thereof differs. Furthermore, the upper and lower beads 20 are identical to the left and right beads 20 aside from their lengths. Hence, while the following descriptions focus on attaching the upper-side bead 20 to the upper frame element 15, the structure of the other beads 20 and the method for attaching the other beads 20 to the frame elements 16, 17, and 18 are the same.

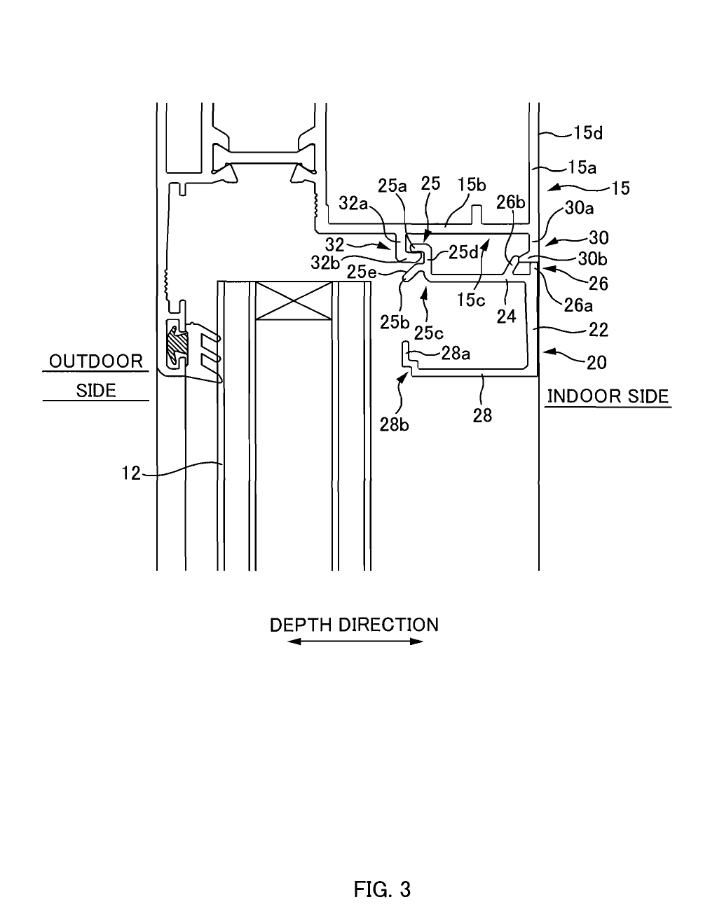

First, the upper frame element 15, to which the upper-side bead 20 is to be attached, is disposed so that a top plate portion 15b having a surface essentially horizontal in the depth direction spans across the upper portion of the glass 12 from a surface plate section 15a, which forms a surface on the indoor side of the sash window assembly, as shown in FIG. 3. A second engaging projection 30 that projects downward flush with the surface plate section 15a, and a first engaging projection 32 provided with a space between itself and the second engaging projection 30, are provided on the lower surface of the top plate portion 15b. The first engaging projection 32 has a wall portion 32a projecting downward from the top plate portion 15b and an inward hook portion 32b projecting toward the indoor side from the bottom of the wall portion 32a. The second engaging projection 30 has a surface wall portion 30a projecting downward flush with the surface plate section 15a and an outward hook portion 30b projecting toward the outdoor direction from the surface wall portion 30a. The upper frame element 15 is, as mentioned earlier, an aluminum member formed through extrusion molding, and thus the first engaging projection 32 and the second engaging projection 30 are formed spanning across the entirety of the width direction. Furthermore, the first engaging projection 32 and the second engaging projection 30 are provided projecting downward from the top plate portion 15b, and thus a recess 15c is formed between the first engaging projection 32 and the second engaging projection 30 on the inner side of the upper frame element 15, or in other words, is recessed in the upward direction.

As illustrated in FIG. 3, the upper-side bead 20 includes the following, as viewed in a state where the bead 20 is attached to the upper frame element 15: an inner face portion 22 that is essentially flush with a surface 15d of the upper frame element 15 on the indoor side; a frame element side horizontal plate section 24 forming a plane that extends horizontally from the upper end of the inner face portion 22 toward the outdoor side; and a face material central side horizontal plate portion 28, formed essentially parallel to the frame element side horizontal plate section 24, extending from the lower end of the inner face portion 22 towards the outdoor side.

A first engaging section 25 is provided on the outdoor side end of the frame element side horizontal plate section 24, whereas a second engaging section 26 is provided on the indoor side end of the frame element side horizontal plate section 24.

As viewed in a state where the bead 20 is attached to the upper frame element 15, the first engaging section 25 has an upper grasping piece 25a and a lower grasping piece 25b that sandwich from the top and bottom of the first engaging projection 32 provided in the upper frame element 15. The upper grasping piece 25a and the lower grasping piece 25b are provided in an extending section 25d that extends in the vertical direction from an outdoor-side edge section 25c, provided in the frame element side horizontal plate section 24. The upper grasping piece 25a is disposed on the upper end side of the extending section 25d, and the lower grasping piece 25b is provided therebeneath, with a space between itself and the upper grasping piece 25a. Furthermore, the lower grasping piece 25b is formed so that its length from the extending section 25d is longer than that of the upper grasping piece 25a. The lower grasping piece 25b is also formed so as to have an angled surface 25e angled downward towards the outdoor side.

As viewed in a state where the bead 20 is attached to the upper frame element 15, the second engaging section 26 has: a rotation limiting projection piece 26a that projects upward, so as to be flush with the inner face portion 22, and is made to contact with the second engaging projection 30 provided in the upper frame element 15; and a movement limiting projection piece 26b projecting upward and positioned further on the outdoor side than the rotation limiting projection piece 26a. The movement limiting projection piece 26b is formed so as to be angled upward and toward the indoor side.

As viewed in a state where the bead 20 is attached to the upper frame element 15, a vertical wall portion 28a is formed in an upward direction on the end of the face material central side horizontal plate portion 28 on the outdoor side, and is formed so as to face the glass 12 with a space therebetween in the depth direction. A stepped portion 28b, recessed toward the inside of the bead 20, is provided in the corner that connects the lower end of the vertical wall portion 28a with the outdoor-side end of the face material central side horizontal plate portion 28.

When the glass 12 is installed and the four beads 20 are attached, a sealant 36 is packed into the space formed between the glass 12, and the vertical wall portions 28a of the four beads 20 and the four stepped portions 28b. The sealant 36 is an elastic material such as rubber or the like, and is pushed in toward the inside of the frame elements from the center side of the glass 12 across the entire circumference thereof after the beads 20 have been attached. For this reason, the sealant 36 makes tight contact with the beads 20 and the glass 12. Furthermore, the beads 20 are pushed toward the indoor side and the glass 12 is pushed toward the outdoor side due to the elasticity of the sealant 36.

Descriptions shall now be provided regarding a method for attaching the upper-side bead 20 to the upper frame element 15.

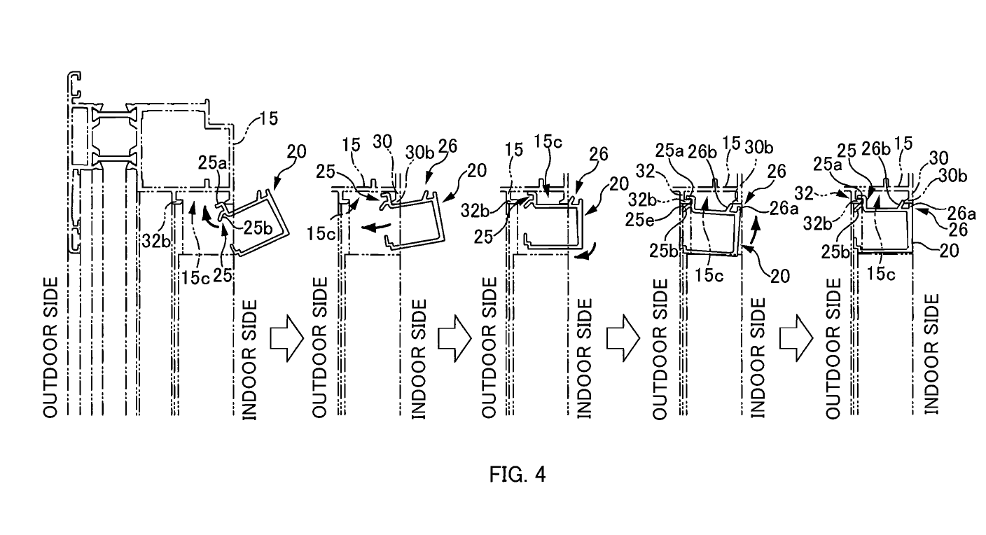

As shown in FIG. 4, the first engaging section 25 of the bead 20 is first inserted into the recess 15c. Here, the tip of the lower grasping piece 25b is formed so as to be positioned lower than the upper surface of the inward hook portion 32b even when the upper grasping piece 25a is made to be contacted with the upper frame element 15 inside the recess 15c.

Next, the bead 20 is moved toward the outdoor side, with the first engaging section 25 positioned inside the recess 15c. At this time, the bead 20 is rotated slightly so as to move the bead 20 downward toward the indoor side, so that the second engaging section 26 does not make contact with the outward hook portion 30b of the second engaging projection 30. Moving the bead 20 in the outdoor direction brings the angled surface 25e of the lower grasping piece 25b into contact with the inward hook portion 32b. Further moving the bead 20 toward the outdoor side moves the bead 20 in the downward direction due to the tip of the inward hook portion 32b and the angled surface 25e; this results in a state where the inward hook portion 32b enters into and is engaged in the space between the upper grasping piece 25a and the lower grasping piece 25b. In this state, the movement limiting projection piece 26b of the second engaging section 26 is positioned further toward the outdoor side than the outward hook portion 30b, and by slightly rotating the bead 20 so that the bead 20 moves upward on the outdoor side, the movement limiting projection piece 26b is made to contact with the tip of the outward hook portion 30b and the rotation limiting projection piece 26a is made to contact with the lower end of the second engaging projection 30, thereby attaching the bead 20 to the upper frame element 15.

Incidentally, conventional beads, as described above, in which the ends of the beads, which are angled (45-degree angles, in this embodiment) and butt against one another, are formed so that the edges of the beads on the frame element side are longer than the inner edges at the center side of the glass. For this reason, it is difficult to attach the conventional beads so as to support all sides of the glass to the four frame elements by moving the beads along the surface of the glass, from the center side of the glass toward the inner sides of the frame elements. To be more specific, although any three of the four conventional beads can be attached with ease, when attaching the remaining one bead after the first three conventional beads have been attached, the conventional bead that is being attached makes contact with two of the other conventional beads that have already been attached adjacent to the bead that is being attached, and thus cannot be attached.

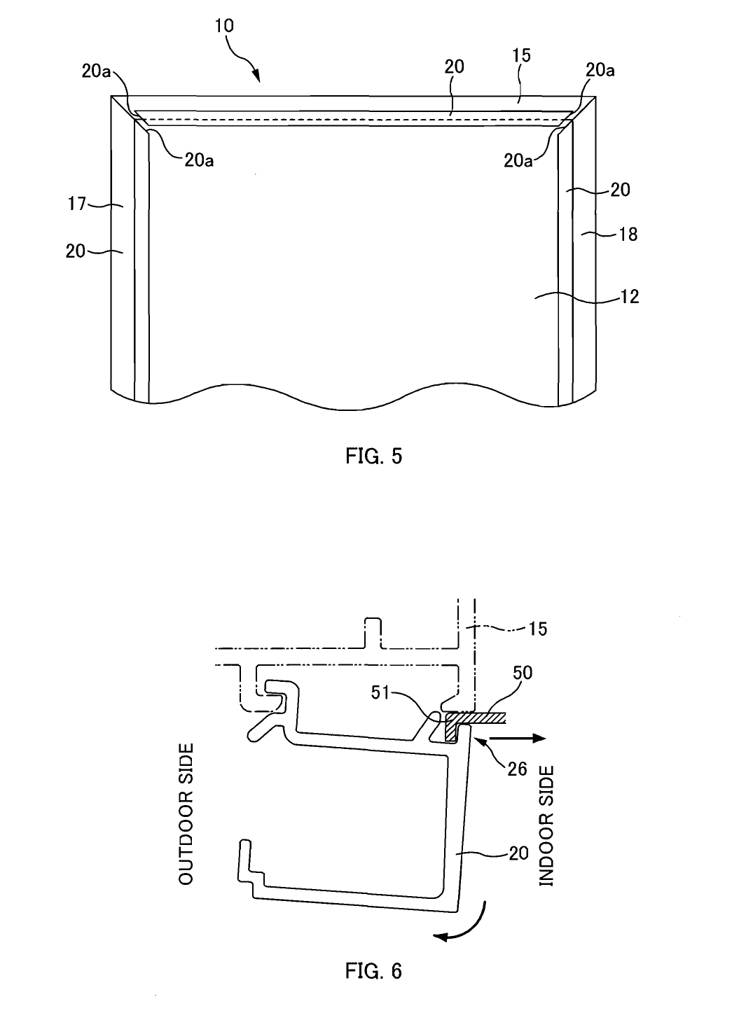

However, with the sash window assembly 1 of this embodiment, when attaching the upper-side bead 20, the first engaging section 25 is inserted and moved into the recess 15c that is recessed toward the inner side of the upper frame element 15, and therefore the position of the upper-side bead 20 at the time of this movement is further toward the inner side of the upper frame element 15 than when the bead 20 is attached to the upper frame element 15. Accordingly, even if two beads 20 are already attached to the left and right vertical frame elements 17 and 18 so as to be adjacent to the upper-side bead 20, it is possible to allow for a space between the upper-side bead 20 and the ends 20a of the two already-attached beads 20 adjacent to the upper-side bead 20 when moving the upper-side bead 20 in the depth direction, as shown in FIG. 5. Because there is a space between the upper-side bead 20 that is being attached and the ends 20a of the adjacent beads 20, the indoor side of the upper-side bead 20 can be moved in the direction away from the second engaging projection 30, and the upper-side bead 20 can therefore be tilted. Furthermore, by tilting the upper-side bead 20 in the direction away from the second engaging projection 30, the movement limiting projection piece 26b can be moved further toward the outdoor side than the second engaging projection 30 without the second engaging section 26 coming into contact with the second engaging projection 30. By moving the movement limiting projection piece 26b further toward the outdoor side than the second engaging projection 30, the first engaging section 25 and the first engaging projection 32 engage with one another, and by further rotating the upper-side bead 20 in the direction that brings the second engaging section 26 closer to the upper frame element 15, the second engaging section 26 and the second engaging projection 30 engage with one another. Therefore, the bead 20 can be attached with ease, even if the ends of the beads 20 are angled and butt against one another.

Furthermore, in a state where the upper-side bead 20 is attached to the upper frame element 15, the movement limiting projection piece 26b makes contact with the outward hook portion 30b of the second engaging projection 30 on the outdoor side due to the second engaging section 26 and the second engaging projection 30 being engaged with one another. Therefore, the movement of the bead 20 in the movement direction in the indoor side direction is limited, and thus the upper-side bead 20 can be attached to the upper frame element 15 in a manner that makes it difficult for the upper-side bead 20 to become detached. At this time, the rotation limiting projection piece 26a is made to contact with the lower end of the second engaging projection 30, and thus the rotation in the direction that brings the second engaging section 26 closer to the upper frame element 15 is limited, and the contacting state between the movement limiting projection piece 26b and the second engaging projection 30 is maintained. Hence the bead 20 can be attached to the upper frame element 15 in a manner that makes it even more difficult for the bead 20 to become detached.

In the state where four beads 20 have been attached, the elastic sealant 36 is packed into the space between the glass 12 and the beads 20, and the movement limiting projection piece 26b and the rotation limiting projection piece 26a press upon the second engaging projection 30 as a result thereof. Therefore, pressure is placed on the upper-side bead 20 so as to limit its movement in the direction opposite the movement direction used when attaching the upper-side bead 20, or in other words, movement toward the indoor side, and its rotation in the direction in which the second engaging section 26 moves away from the upper frame element 15. Accordingly, the upper-side bead 20 can be attached to the upper frame element 15 in a manner that makes it even more difficult for the upper-side bead 20 to become detached. Furthermore, reactive force arises between the sealant 36 and the glass 12, thus making it possible to securely hold the glass 12 in place.

The beads 20 can be removed easily by, for example as illustrated in FIG. 6, rotating the bead 20 in the direction in which the indoor side of the upper-side bead 20 moves away from the upper frame element 15, inserting a jig 50 having a key section 51 from the indoor side into the space between the upper-side bead 20 and the upper frame element 15, engaging the key section 51 with the second engaging section 26, and pulling the bead in the indoor side direction.

Although the configuration and effects of the present embodiment have been described using the upper-side bead 20 and the upper frame element 15 as examples, the same applies to the lower-side bead 20 and the lower frame element 16, as well as the left and right beads 20 and the left and right vertical frame elements 17 and 18. Furthermore, although the abovementioned descriptions give an example in which the upper-side bead 20 is attached last out of the four beads 20, the bead 20 that is attached last may be any of the upper, lower, left, and right beads 20. This is because the present configuration is such that the first engaging section 25 of each of the beads 20 is inserted into the recess of the frame elements 15, 16, 17, and 18, respectively, and a space is formed between each bead 20 and the ends 20a of the bead 20 adjacent thereto.

Furthermore, although the face material has been described as glass in this embodiment, the face material is not limited to glass.

Furthermore, although the sash window assembly of this embodiment has been described as a sash window assembly having sashes supported so as to be rotatable on one end, in the width direction, of a sash frame, the embodiment may be applied to any sash window assembly as long as that sash window assembly has a face material attached using beads, such as a sash window assembly having a sliding door that slides on one or both sides, a sash window assembly having a fixed window attached so as to be unopenable in the sash frame, and so on.

The foregoing embodiment is for the purpose of elucidating the invention and is not to be interpreted as limiting the invention. The invention can of course be changed and altered without departing from the gist thereof and equivalents are intended to be embraced therein.

What is claimed is:

1. A sash window assembly comprising a face material provided in an opening section that is open to an indoor side and an outdoor side, a frame section provided within the opening section, and beads attached to the frame section with the ends of the beads angled and butted against one another, the beads for pressing upon the face material from one direction of the indoor and outdoor directions,
wherein each of the beads includes a first engaging section and a second engaging section, the first engaging section engaging with the frame section at a front-side in a movement direction, the second engaging section engaging with the frame further toward a rear-side in the movement direction than the first engaging section, when the bead is moved in the movement direction following along a depth direction;
the frame section includes a first engaging projection that engages with the first engaging section, a second engaging projection that engages with the second engaging section, and a recess provided between the first engaging projection and the second engaging projection, the recess being recessed toward an inner side of the frame section; and
each of the beads is moved with the first engaging section of each bead inserted into the recess, the first engaging section being engaged with the first engaging projection in a state where the bead is tilted so that the second engaging section moves away from the frame section, the second engaging section being engaged with the second engaging projection by rotating the bead in a direction that brings the second engaging section closer to the frame section.

2. A sash window assembly according to claim 1,
wherein the second engaging section includes a movement limiting projection piece that limits the movement of the bead toward the rear-side in the movement direction; and
the movement limiting projection piece is made to contact with the second engaging projection at the front-side in the movement direction by the second engaging section being engaged with the second engaging projection.

3. A sash window assembly according to claim 1,
wherein the second engaging section includes a rotation limiting projection piece that limits the rotation of the bead in the direction that brings the second engaging section closer to the frame section; and
the rotation limiting projection piece is made to contact with the second engaging projection by the second engaging section being engaged with the second engaging projection.

4. A sash window assembly according to claim 1,
wherein an elastic sealant is provided between the face material and the beads; and
the movement limiting projection piece and the rotation limiting projection piece are pressed upon the second engagement projection by the sealant.
